(19) United States
(12) Patent Application Publication
(10) Pub. No.: US 2003/0115964 A1
(43) Pub. Date: Jun. 26, 2003

(54) System for ultrasonic tomography

(76) Inventor: Katsuhiko Shinohara, Kakogawa-shi (JP)

Correspondence Address: Katsuhiko Shinohara, 669-20, Kimura, Kakogawa-choo, Kakogawa-shi, Hyogo, 675-0038, JP

(21) Appl. No.: 10/230,419

(22) Filed: Aug. 30, 2002

(30) Foreign Application Priority Data
Dec. 25, 2001 (JP) 2001-403291

(51) Int. Cl. G01N 29/00

(52) U.S. Cl. 73/606

(57) ABSTRACT

An ultrasonic tomographic image is obtained by using the difference between intensities of two echoes from the same analyte by two ultrasonic beams emitted through a vibrator element group of a probe A and through some vibrator elements within this group, respectively.

### BACKGROUND OF THE INVENTION

The present invention relates to a system for ultrasonic tomography.

The system for conventional ultrasonic tomography improves the lateral resolution with both an acoustic lens and electronic focuses.

This has the problem that it cannot cope with diagnosing the analyte near the probe due to bad lateral resolution in this area.

Thus, two or three kinds of probes are required for diagnosing the human body with ultrasound.

### SUMMARY OF THE INVENTION

The object of the present invention is to provide a low-cost system for ultrasonic tomography that can diagnose the analytes at all depth of the human body with one probe.

In order to achieve these objectives, said present invention gets an ultrasonic tomographic image of the human body by using the difference between intensites of two echoes from the same analyte in a human body by means of two ultrasonic beams emitted through a vibrator element group of a probe and through some vibrator elements within this group, respectively.

### BRIEF DESCRIPTION OF THE DRAWING

FIG. 1 shows the ultrasonic wave transmission/receiving component of the probe of an embodiment.

FIG. 2 shows the ultrasonic intensity distribution graph transmitted through a vibrator element group (1, 2, 3, . . . , X, 1′, 2′, 3′, . . . , X′) at a location near the probe of an embodiment in the direction of the short axis of the probe.

FIG. 3 shows the ultrasonic intensity distribution graph transmitted through a vibrator element group (1, 2, 3, . . . , X) at a location near the probe of an embodiment in the direction of the short axis of the probe.

### DESCRIPTION OF THE PREFERRED EMBODIMENTS

An embodiment of the present invention is explained hereiafter referring to Figures.

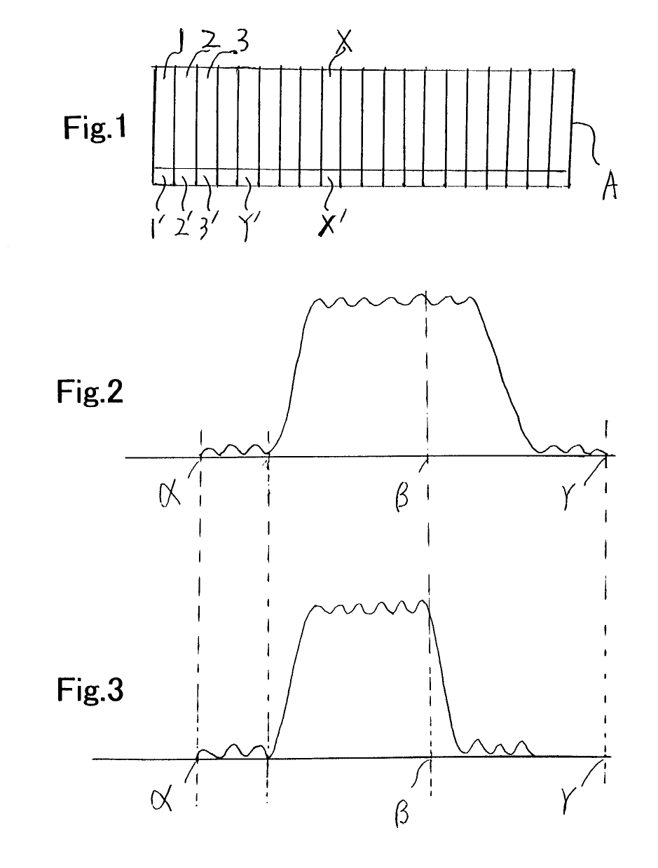

In FIG. 1, the ultrasonic beam is emitted through a vibrator element group (1, 2, 3, . . . , X, 1′, 2′, 3′, X′) of the probe A, and the echoes from the analytes of the human body near said probe A, are received.

Then, another ultrasonic beam is emitted through a vibrator element group (1, 2, 3, . . . , X) of said probe A, and the echoes from the analytes of the human body near said probe A are also received.

The ultrasonic tomohraphic image near said probe A of the present invention is obtained by using the difference between intensities of the two above-mentioned echoes from the same analyte in a human body near said probe A.

In FIGS. 1 and 2, the two shapes of the ultrasonic intensity distribution graphs are almost the same in the range from α to β.

Therefore, the above-mentioned difference between intensities of said two echoes gives almost the same intensity of the echo from the each analyte near the said probe A in the range from β to γ.

Thus, the lateral resolution of the system for ultrasonic tomography of the present invention is superior to that of the system for conventional ultrasonic tomography in the direction of the short axis of their respective probes at a location near their respective probes.

In another embodiment of the present invention, the ultrasonic tomographic image is obtained by using the difference between intensities of the two echoes from the same analyte near said probe A in a human body by means of two ultrasonic beams emitted through a vibrator element group (1, 2, 3, . . . , X, 1′, 2′, 3′, . . . , X′) and through a vibrator element group (1, 2, 3, . . . , X, 1′ . . . , Y′), respectively.(with the value of X′ being much larger than that of Y′.)

In this embodiment, the lateral resolution of the system for ultrasonic tomohraphy of the present invention is superior to that of the system for conventional ultrasonic tomography in the direction of both short and long axies of their said respective probes at a location near their respective probes.

The thyroid gland, mammae, supurficial lymph-nodes, muscles, tendons, etc., can be examined with only one probe in the present invention for the examination of liver and pancreas.

The lateral resolution in the system for ultrasonic tomography of the present invention improves inversely, in proportion to the distance between said probe A and the analytes in a human body.

While a few embodiments of the invention have been illustrated and described in detail, it is particularly understood that the invention is not limited thereto or thereby.

What is claimed is:

1. A system for ultrasonic tomography comprising; an ultrasonic tomographic image by means of a differentiating between intensites of two echoes from the same analyte by means of two ultrasonic beams emitted through a vibrator element group of a probe and through some vibrator elements within this group, respectively.

2. Said system for ultrasonic tomography of claim 1, wherein said two echoes are obtained from two ultrasonic beams emitted through a vibrator element group (1, 2, 3, . . . , X, 1′, 2′, 3′, . . . , X′) and through a vibrator element group (1, 2, 3, . . . , X), respectively.

3. Said system for ultrasonic tomography of claim 1, wherein said two echoes are obtained from two ultrasonic beams emitted through a vibrator element group (1, 2, 3, . . . , 1′, 2′, 3′, . . . , X′) and through a vibrator element group (1, 2, 3, . . . , X, 1′, . . . , Y′), respectively.
